(19) United States
(12) Patent Application Publication
(10) Pub. No.: US 2021/0225042 A1
(43) Pub. Date: Jul. 22, 2021

(54) CONFERENCE ROOM OCCUPANCY INDICATOR

(71) Applicant: Lenovo (Singapore) Pte. Ltd., Singapore (SG)

(72) Inventors: Rod D. Waltermann, Rougemont, NC (US); Anastassios Markas, Chapel Hill, NC (US)

(21) Appl. No.: 16/748,359

(22) Filed: Jan. 21, 2020

(51) Int. Cl. G06T 11/00; G06K 9/00; G01C 21/20; G06Q 10/02

(52) U.S. Cl. CPC G06T 11/00; G06Q 10/02; G01C 21/206; G06K 9/00671

(57) ABSTRACT

An approach is provided that uses augmented/virtual reality to identify occupied meeting rooms. The approach captures, at a digital camera, a digital image of an exterior of a closed-door meeting room. The meeting room in the digital image is identified and a set of data pertaining to the identified meeting room is retrieved. The set of data indicates whether the meeting room is currently occupied. The captured digital image is displayed on a display screen with an overlay of the retrieved set of data indicating whether the meeting room is currently occupied.

### BACKGROUND

Available, unoccupied meeting rooms are often difficult to find in a busy organization. When the meeting room door is shut, someone looking for an available meeting room often opens the meeting room door to check if it is being used, often causing an interruption to the meeting that is taking place. Not only is the checking disruptive to the meeting participants, but it is often time consuming, frustrating, and difficult for the employee who needs a meeting room to find one that is available.

### SUMMARY

An approach is provided that uses augmented/virtual reality to identify occupied meeting rooms. The approach captures, at a digital camera, a digital image of an exterior of a closed-door meeting room. The meeting room in the digital image is identified and a set of data pertaining to the identified meeting room is retrieved. The set of data indicates whether the meeting room is currently occupied. The captured digital image is displayed on a display screen with an overlay of the retrieved set of data indicating whether the meeting room is currently occupied.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram depicting the components used in providing a meeting room occupancy indicator as an overlay on an alternate reality/virtual reality (AR/VR) device;

FIG. 4 is a flowchart showing steps taken by a process that sets up users and data types to indicate the level, or detail, of meeting room availability data provided to users;

FIG. 5 is a flowchart showing steps taken by a process that operates on an AR/VR device to show overlays of meeting room availability data; and

FIG. 6 is a flowchart showing steps taken by a process that retrieve particular meeting room request data to use in the AR/VR display.

### DETAILED DESCRIPTION

The figures show an approach that provides an AR/VR solution (Glasses, phone app, screen overlay, etc.) to finding an available meeting room and couples the solution with a smart office device that is capable of detecting if a room is currently occupied, such as a room sensor that might also control the lighting and turn the lights off when the room in unoccupied. This approach can change the room door in an overlaid image to “green” to indicate that the room is unoccupied or to “red” to indicate that the room is currently occupied and “yellow” to indicate that while the room is not currently occupied it has been reserved by someone else. Additionally data about the room, such as the meeting room schedule, can be overlaid on the display, such as appearing to hover over the door, or on the room to show when it would be available.

Alternately, a “light” path can be overlaid on the floor through the AR viewing device to show a path to the nearest available meeting room. This allows less meeting interruptions and also greatly aids in finding an unoccupied meeting room. Additionally, the approach connects the AR/VR device to local smart office devices to provide identification of occupied and unoccupied meeting rooms.

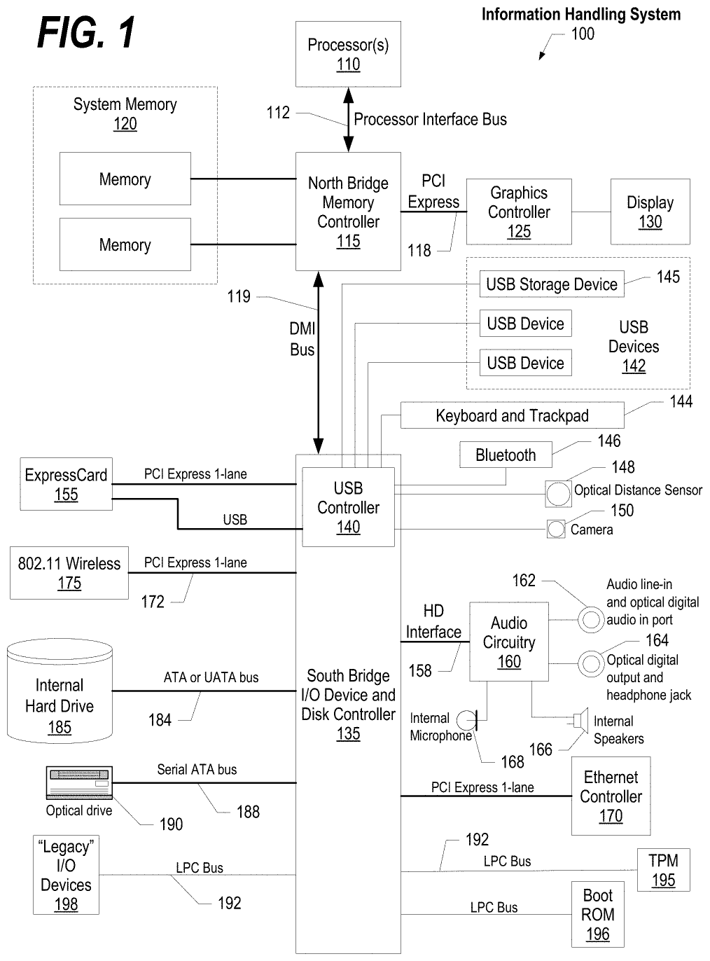

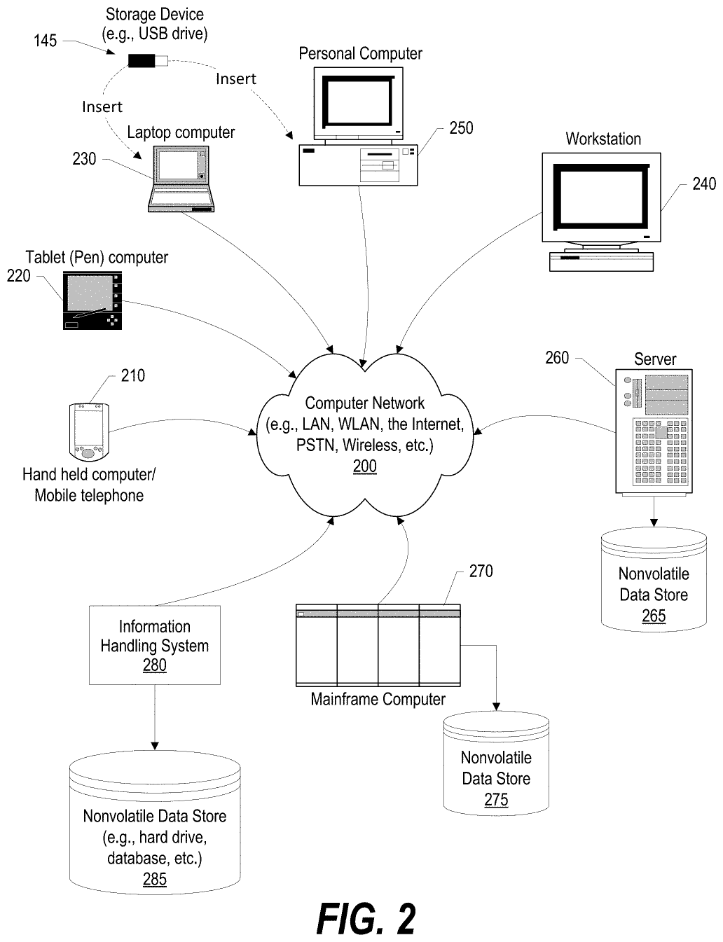

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a device that is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Accelerometer 180 connects to Southbridge 135 and measures the acceleration, or movement, of the device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may be a device that can take many forms. For example, an information handling system may take the form of a desktop device, server device, portable device, laptop device, notebook device, or other form factor device. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of devices that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling system devices include pen, or tablet, device 220, laptop, or notebook, device 230, workstation device 240, personal computer system device 250, and server device 260. Other types of information handling system devices that are not individually shown in FIG. 2 are represented by information handling system device 280. As shown, the various information handling system devices can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

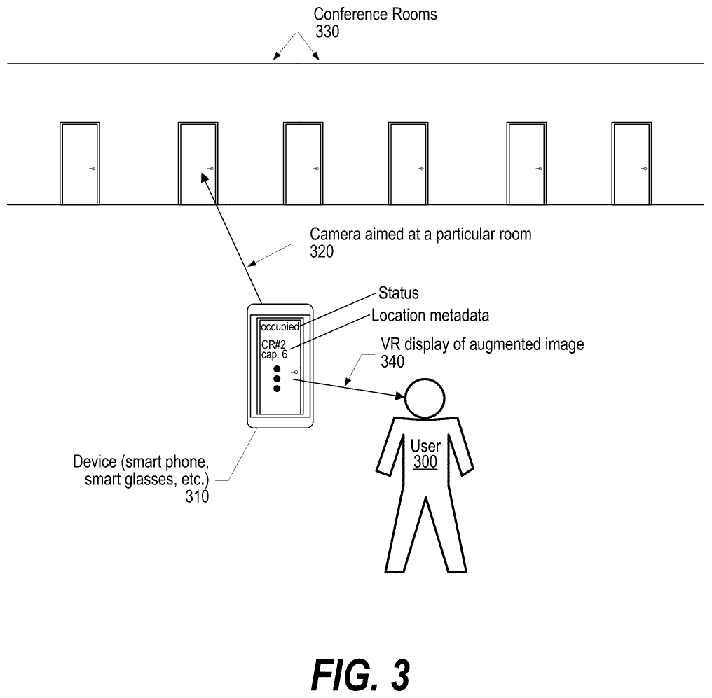

FIG. 3 is a component diagram depicting the components used in providing a meeting room occupancy indicator as an overlay on an alternate reality/virtual reality (AR/VR) device. User 300 utilizes device 310 that is capable of providing an AR/VR display, such as a smart phone that is equipped with a digital camera and sufficient processing capabilities, smart glasses that are eyeglasses that include digital cameras and processing capabilities that can overlay images on the glass surface so that the overlaid material is visible to the user, or other type of information handling system that has a digital camera and a display screen.

User 300 directs digital camera 320 included in AR/VR device 310 to the exterior of a particular meeting room by pointing the device's digital camera in the direction of the selected meeting room. In the example, several conference rooms 330 are shown along a common wall with the user directing the digital camera towards a particular meeting room amongst the set of rooms.

The display screen of the device displays the view through the digital camera.

In the example shown in FIG. 3, the door of meeting room appears on the display screen as a digital image. This digital image is overlaid with information about the selected meeting room, such as the status of the meeting room (e.g., occupied, unoccupied, unoccupied but scheduled, etc.). In addition, metadata about the meeting room and, in some cases, its schedule can also appear. In the example, the meeting room number is displayed (“CR #2”) along with the capacity of the meeting room (“cap. 6”). User 300 views augmented reality (AR) depiction 340 of the meeting room with the augmented reality view showing both the selected door as wall as the current status of the selected room and the selected meeting room's metadata indicating, in this example, the meeting room's size and identification number.

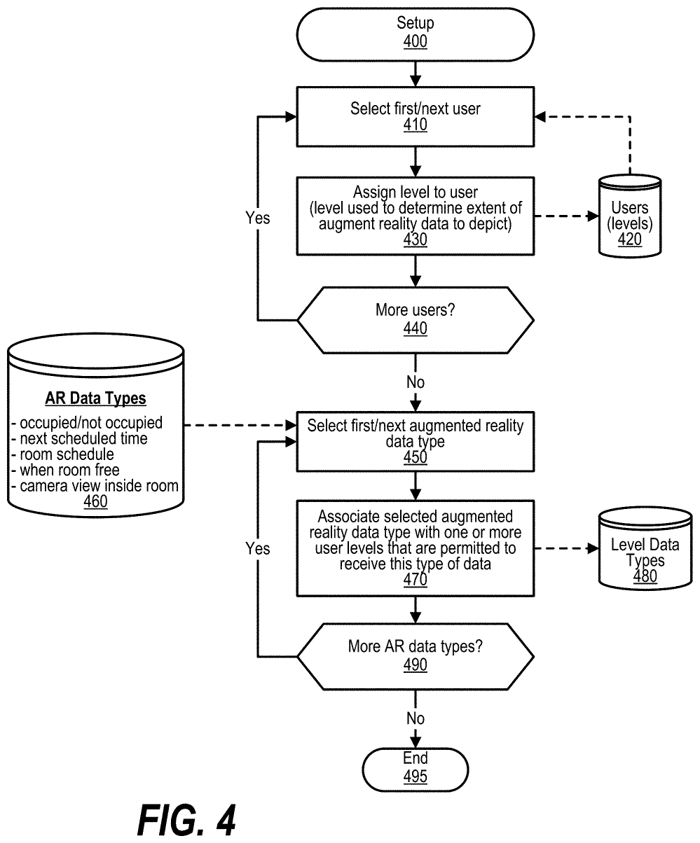

FIG. 4 is a flowchart showing steps taken by a process that sets up users and data types to indicate the level, or detail, of meeting room availability data provided to users. FIG. 4 processing commences at 400 and shows the steps taken by a setup process. At step 410, the process selects the first user from the list of users. The users are selected from data store 420, such as an employee directory or the like.

At step 430, the process receives a level from an administrator that is performing the setup process. The level is assigned to the selected user with the level being used to determine extent of augment reality data to depict. Based on their level, some users can view more detail on the AR display than other users. For example, while a user with a low level might only see that a meeting room is occupied or unoccupied, a user with a high level, such as a site manager, might see the participants in any given meeting room and the subject of the meeting if the meeting has been scheduled. The detail that is assigned to level is described below. The level assigned to the selected user is associated with the user and stored in data store 420.

The process determines as to whether there are more users to process (decision 440). If there are more users to process, then decision 440 branches to the ‘yes’ branch which loops back to step 410 to select and process the next user from data store 420. This looping continues until there are no more users needing to be processed, at which point decision 440 branches to the ‘no’ branch exiting the loop.

The next loop determines what details users at each level are provided when using the system to identify occupied and unoccupied meeting rooms. At step 450, the process selects the first augmented reality data type from data store 460. Examples of different data types that determine the detail that each level can view include a simple occupied/unoccupied type, a next scheduled time of the meeting room type, a meeting room schedule view type, a type that provides a next time when the meeting room is available, and a camera view inside room to view the actual meeting that is currently taking place in the meeting room.

At step 470, the process associates the selected augmented reality data type with one or more user levels that are permitted to receive this type, or detail, of data when using the system to identify occupied and unoccupied meeting rooms. The association between the user levels and the selected augmented reality data type is stored in data store 480.

The process determines whether there are more augmented reality data types to process (decision 490). If there are more augmented reality data types to process, then decision 490 branches to the ‘yes’ branch which loops back to step 450 to select and process the next augmented reality data type from data store 460. This looping continues until there are no more augmented reality data types to process, at which point decision 490 branches to the ‘no’ branch exiting the loop. Setup processing shown in FIG. 4 thereafter ends at 495.

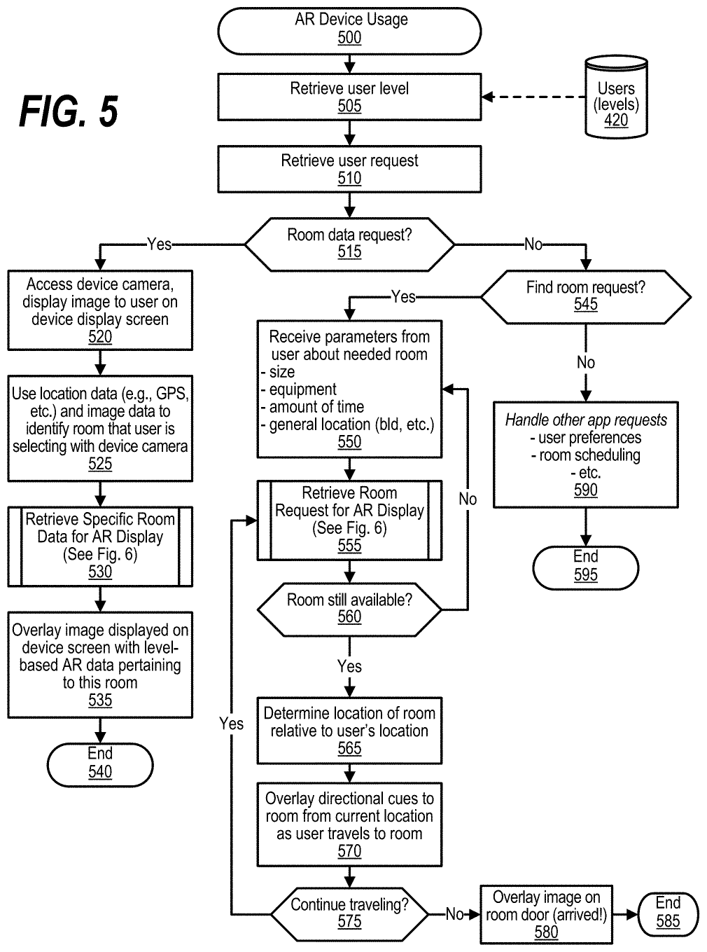

FIG. 5 is a flowchart showing steps taken by a process that operates on an AR/VR device to show overlays of meeting room availability data. FIG. 5 processing commences at 500 and shows the steps taken by a process that provides augmented reality (AR) to a device when a user is identifying meeting rooms that are occupied and unoccupied. At step 505, the process retrieves the user's level from data store 420. This level determines the level of detail that the user is provided on the user's AR display. At step 510, the process retrieves a request from the user. The process determines as to whether the user has made a meeting room data (availability) request or some other sort of request (decision 515). If the user has made a room data request, then decision 515 branches to the ‘yes’ branch to perform steps 520 through 540. On the other hand, if a different type of request has been made, then decision 515 branches to the ‘no’ branch to perform steps 545 through 595.

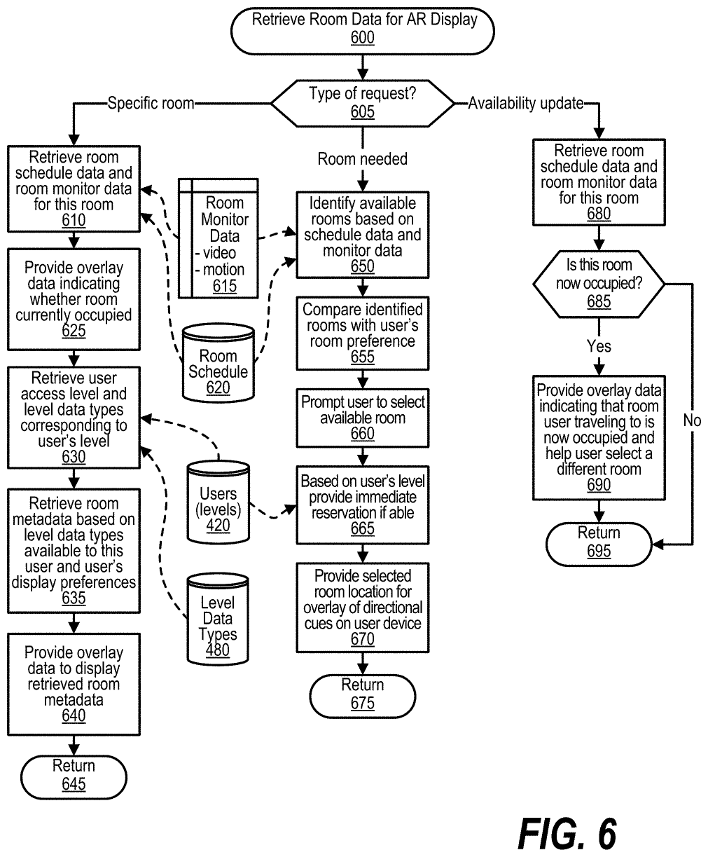

When the user has made a room data request, then steps 520 through 540 are performed. At step 520, the process accesses the user's device camera and displays the image from the camera to the user on the device's display screen. At step 525, the process uses the user's current location data (e.g., using the user's device GPS capabilities, etc.) and the current image data in order to identify the meeting room that user is selecting with device camera. At predefined process 530, the process performs the Retrieve Specific Room Data for AR Display routine (see FIG. 6 and corresponding text for processing details). At step 535, the process overlays the image displayed on the user's device screen with the level-based AR data pertaining to the identified meeting room. Processing of the user's request thereafter ends at 540.

Returning to decision 515, if the user's request is not a meeting room data request, then decision 515 branches to the ‘no’ branch. The process then determines whether the user has made a find available meeting room request or some other type of request (decision 545). If the user has made a find available meeting room request, then decision 545 branches to the ‘yes’ branch to perform steps 550 through 585. On the other hand, if the user has made some other type of request, then decision 545 branches to the ‘no’ branch whereupon, at step 590, the process handles some other type of user request through the app, such as setting up the user preferences, meeting room scheduling, etc., and processing thereafter ends at 595.

When the user has made a find available meeting room request, then steps 550 through 585 are performed. At step 550, the process receives parameters from user about the user's desired meeting room, such as the size of the meeting room, equipment available in the meeting room, the amount of time that the user needs to have the meeting room, the general location of the meeting room (e.g., the building, floor, etc.) and the like. At predefined process 555, the process performs the Retrieve Room Request for AR Display routine (see FIG. 6 and corresponding text for processing details). The process determines as to whether the user's desired meeting room is still available if the user was unable to reserve the room and is instead trying to get the meeting room while it is still unoccupied (decision 560).

If the meeting room still available, then decision 560 branches to the ‘yes’ branch to perform steps 565 through 570. On the other hand, if the meeting room is no longer available, decision 560 loops back to step 550 where the user can refine the desired meeting room parameters and perform predefined process 555 to retrieve a meeting room request for the user's AR display. This looping continues until the meeting room selected by the user is available, at which point decision 560 branches to the ‘yes’ branch exiting the loop.

When the user's desired meeting room is still available then steps 565 and 570 are performed. At step 565, the process determines the geographic location of the desired room relative to user's location and routes a path from the user's current location to the meeting room location. At step 570, the process overlays directional cues to the user's desired meeting room location from the user's current location as the user travels to the meeting room. The process determines as to whether the user continues traveling towards the meeting room or has arrived at the meeting room (decision 575).

If the user continues traveling towards the meeting room, then decision 575 branches to the ‘yes’ branch which loops back to predefined process 555 to make sure the meeting room is still available (taking corrective action if the room is no longer available). This looping continues until the user reaches the desired meeting room, at which point decision 575 branches to the ‘no’ branch exiting the loop. At step 580, the process overlays an AR image on the user's AR display, such as hovering on the meeting room door indicating that the user has arrived at the desired (and still unoccupied) meeting room. Processing of the user's request thereafter ends at 585.

FIG. 6 is a flowchart showing steps taken by a process that retrieve particular meeting room request data to use in the AR/VR display. FIG. 6 processing commences at 600 and shows the steps taken by a process that retrieves meeting room data to display on the user's AR capable device screen. At 605, the process determines the type of request being made to the routine. If the request pertains to a specific meeting room, then decision 605 branches to the “specific room” branch to perform steps 610 through 645. If the request pertains to the user's desire for an unoccupied meeting room, then decision 605 branches to the “room needed” branch to perform steps 650 through 675. Finally, if the request is to check if a particular meeting room is still unoccupied, then decision 605 branches to the “availability update” branch to perform steps 680 through 695.

When the request pertains to a specific meeting room, then steps 610 through 645 are performed. At step 610, the process retrieves the meeting room schedule data and room monitor data for this meeting room with the schedule data being retrieved from data store 620. In addition, room monitor data from sensors in the meeting room are retrieved from memory area 615, such as video from inside the meeting room and motion detectors inside the meeting room. At step 625, the process provides AR overlay data indicating whether the specific meeting room is currently occupied or unoccupied. At step 630, the process retrieves the user's access level from data store 420 and level data types corresponding to the retrieved user level from data store 480.

At step 635, the process retrieves meeting room metadata based on the level data types available to this particular user and the user's display preferences. As previously described, a low user level might only allow the user data regarding whether the room is occupied or unoccupied, while a high user level might provide extensive detail about the meeting room, such as upcoming schedules, current participants of a meeting currently taking place in the meeting room, etc. At step 640, the process provides the overlay data as AR data to display the retrieved room's metadata. FIG. 6 processing thereafter returns to the calling routine (see FIG. 5) at 645.

When the request pertains to a request for any available meeting room, then steps 650 through 675 are performed. At step 650, the process identifies available rooms based on meeting room schedule data retrieved from data store 620 and meeting room monitor data retrieved from memory area 615. At step 655, the process compares the available meeting rooms identified by step 650 with the user's meeting room preferences (e.g., size, equipment, etc.). At step 660, the process prompts the user to select one of the available meeting rooms.

At step 665, the process may make an immediate reservation of the selected meeting room if the user's level is high enough to allow for immediate reservations (e.g., site manager, senior technical employee, etc.). At step 670, the process provides the selected room geographic location in order to provide overlay of directional cues on user's AR device directing the user to the desired meeting room. FIG. 6 processing thereafter returns to the calling routine (see FIG. 5) at 675.

When the request pertains to an availability update for a specific meeting room, then steps 680 through 695 are performed. At step 680, the process retrieves the meeting room schedule data and the meeting room monitor data for this room. The process determines as to whether is this meeting room that was unoccupied is now occupied (decision 685). If is this meeting room is now occupied, then decision 685 branches to the ‘yes’ branch whereupon, at step 690, the process provides overlay data indicating that room that the user is currently traveling to is now occupied and assists the user in finding a different meeting room. On the other hand, if the meeting room is still unoccupied, then decision 685 branches to the ‘no’ branch bypassing step 690. FIG. 6 processing thereafter returns to the calling routine (see FIG. 5) at 695.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. As used herein, a computer readable storage medium does not include a transitory signal.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While particular embodiments have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to others containing only one such element, even when the same claim includes the introductory phrases “one or more” or “at least one” and indefinite articles such as “a” or “an”; the same holds true for the use in the claims of definite articles.

What is claimed is:

1. A method, implemented by an information handling system comprising a processor, a memory accessible by the processor, and a network interface connecting the information handling system to a computer network, the method comprising:
capturing, at a digital camera accessible by the information handling system, a digital image of an exterior of a closed-door meeting room;
identifying the meeting room in the digital image;
retrieving a set of data pertaining to the identified meeting room, wherein the set of data indicates whether the meeting room is currently occupied; and
displaying the captured digital image overlaid with the retrieved set of data on a display screen accessible from the information handling system.

2. The method of claim 1 further comprising:
identifying a user access level that pertains to a user of the information handling system, wherein a detail of the set of data changes based upon the user access level.

3. The method of claim 1 further comprising:
receiving a meeting room request at the information handling system;
identifying an available meeting room based on the received request;
overlaying, on the display, a current view of the digital camera with a set of directional cues that direct the user to the identified available meeting room, wherein the directional cues change as the user moves towards a

4. The method of claim 3 wherein the meeting room request includes one or parameters wherein at least one of the parameters is selected from the group consisting of a meeting room size, a meeting time, a general meeting room location, and a meeting room amenity.

5. The method of claim 3 further comprising:
receiving a meeting room selection from the user of the information handling system;
reserving the selected meeting room;
retrieving a geographic location of the selected meeting room; and
computing a route from a user's current location to the retrieved geographic location, wherein the cues are overlaid to direct the user along the computed route.

6. The method of claim 3 further comprising:
receiving a meeting room selection from the user of the information handling system;
retrieving a geographic location of the selected meeting room; and
computing a route from a user's current location to the retrieved geographic location, wherein the cues are overlaid to direct the user along the computed route.

7. The method of claim 6 further comprising:
while the user is being directed along the computed route:
periodically checking a status of the selected meeting room; and
informing the user when the selected meeting room becomes

8. An information handling system comprising:
one or more processors;
a memory coupled to at least one of the processors;
a network interface that connects the information handling system to a computer network; and
a set of computer program instructions stored in the memory and executed by at least one of the processors in order to perform actions comprising:
capturing, at a digital camera accessible by the information handling system, a digital image of an exterior of a closed-door meeting room;
identifying the meeting room in the digital image;
retrieving a set of data pertaining to the identified meeting room, wherein the set of data indicates whether the meeting room is currently occupied; and
displaying the captured digital image overlaid with the retrieved set of data on a display screen accessible from the information handling system.

9. The information handling system of claim 8 wherein the actions further comprise:
identifying a user access level that pertains to a user of the information handling system, wherein a detail of the set of data changes based upon the user access level.

10. The information handling system of claim 8 wherein the actions further comprise:
receiving a meeting room request at the information handling system;
identifying an available meeting room based on the received request;
overlaying, on the display, a current view of the digital camera with a set of directional cues that direct the user to the identified available meeting room, wherein the directional cues change as the user moves towards a location of the identified available meeting room.

11. The information handling system of claim 10 wherein the meeting room request includes one or parameters wherein at least one of the parameters is selected from the group consisting of a meeting room size, a meeting time, a general meeting room location, and a meeting room amenity.

12. The information handling system of claim 10 wherein the actions further comprise:
receiving a meeting room selection from the user of the information handling system;
reserving the selected meeting room;
retrieving a geographic location of the selected meeting room; and
computing a route from a user's current location to the retrieved geographic location, wherein the cues are overlaid to direct the user along the computed route.

13. The information handling system of claim 10 wherein the actions further comprise:
receiving a meeting room selection from the user of the information handling system;
retrieving a geographic location of the selected meeting room; and
computing a route from a user's current location to the retrieved geographic location, wherein the cues are overlaid to direct the user along the computed route.

14. The information handling system of claim 13 wherein the actions further comprise:
while the user is being directed along the computed route:
periodically checking a status of the selected meeting room; and
informing the user when the selected meeting room becomes occupied.

15. A computer program product comprising:
a non-transitory computer readable storage medium, comprising computer program code that, when executed by an information handling system, executes actions comprising:
capturing, at a digital camera accessible by the information handling system, a digital image of an exterior of a closed-door meeting room;
identifying the meeting room in the digital image;
retrieving a set of data pertaining to the identified meeting room, wherein the set of data indicates whether the meeting room is currently occupied; and
displaying the captured digital image overlaid with the retrieved set of data on a display screen accessible from the information handling system.

16. The computer program product of claim 15 wherein the actions further comprise:
identifying a user access level that pertains to a user of the information handling system, wherein a detail of the set of data changes based upon the user access level.

17. The computer program product of claim 15 wherein the actions further comprise:
receiving a meeting room request at the information handling system;
identifying an available meeting room based on the received request;
overlaying, on the display, a current view of the digital camera with a set of directional cues that direct the user to the identified available meeting room, wherein the directional cues change as the user moves towards a location of the identified available meeting room.

18. The computer program product of claim 17 wherein the meeting room request includes one or parameters wherein at least one of the parameters is selected from the group consisting of a meeting room size, a meeting time, a general meeting room location, and a meeting room amenity.

19. The computer program product of claim 17 wherein the actions further comprise:
receiving a meeting room selection from the user of the information handling system;
reserving the selected meeting room;
retrieving a geographic location of the selected meeting room; and
computing a route from a user's current location to the retrieved geographic location, wherein the cues are overlaid to direct the user along

20. The computer program product of claim 17 wherein the actions further comprise:
receiving a meeting room selection from the user of the information handling system;
retrieving a geographic location of the selected meeting room; and
computing a route from a user's current location to the retrieved geographic location, wherein the cues are overlaid to direct the user along the computed route.
